(19) United States
(12) Patent Application Publication
(10) Pub. No.: US 2009/0215466 A1
(43) Pub. Date: Aug. 27, 2009

(54) MOBILE PHONE BASED SYSTEM FOR DISABLING A CELL PHONE WHILE TRAVELING

(76) Inventors: Darcy Ahl, Darien, CT (US); Frank Farrell, Wilton, CT (US); Jose M. Fernandez, Sunrise, FL (US); Joe Mangione, New Canaan, CT (US); Stephen Vowell, Houston, TX (US)

Correspondence Address: EDWARDS ANGELL PALMER & DODGE LLP, P.O. BOX 55874, BOSTON, MA, 02205, US

(21) Appl. No.: 12/040,581

(22) Filed: Feb. 29, 2008

Related U.S. Application Data
(60) Provisional application No. 61/030,931, filed on Feb. 22, 2008.

(51) Int. Cl. H04Q 7/20

(52) U.S. Cl. 455/456.1

(57) ABSTRACT

The invention describes a method implemented on a mobile phone that will disable a cellular phone to prevent an incoming and outgoing or re-route an incoming cellular phone call/text/video/messages and the like if the cellular phone is known to be moving at a predetermined speed corresponding to an unsafe operation of a vehicle. The system and method will determine if the cellular phone is travelling at the predetermined speed and if so will alert the user, then perform any one or all of, a set of predetermined actions such as shutdown the phone, re-route all call to voice messages, store all text messages, shutdown the display, prevent outbound calling/texting, and the like. The invention prevents an individual from using their cellular phone while operating a moving vehicle at or above a predetermined speed.

### CROSS-REFERENCE TO RELATED APPLICATIONS

This Application is a Non-Provisional claiming priority under 35 U.S.C. 119(e) to U.S. Provisional Application No. 61/030,931, filed Feb. 22, 2008.

### BACKGROUND OF THE INVENTION

Although ubiquitous in use, operating a motor vehicle continues to be a dangerous activity requiring the full attention of the driver. Distractions are often the key reason for accidents; accidents which are too often fatal. Car accidents in particular, have been directly linked to the use of a cellular phone for conversation or text messaging. Today cellular communication systems do not account for disabling or re-routing phone calls, or the like, while in a moving vehicle. This lack of technology and the enormous increase in cellular phone use, even while driving, has created a need to implement solutions that would minimize potential hazardous conditions such as operating a moving vehicle while communicating on a cell phone.

There exist today cellular jamming systems that can be installed in a moving vehicle to prevent any phone calls from being received within a particular geographical area. The problem with this prior art solution is that it is unlawful to implement in the U.S. It also does not discriminate between the targeted cell phone and other cellular phones in the same moving vehicle (such as passenger phones) that need not be blocked and as such all parties will be blocked out from receiving calls indiscriminately. There is also a possibility that the cellular jamming system can reach other nearby moving vehicles and inadvertently disable their ability to receive calls as well.

### BRIEF SUMMARY OF THE INVENTION

Use is made of existing cellular phone positioning technology to disable the phone while the user of the phone is operating a vehicle. The cell phone includes a location based tracking system. The cell phone includes a cellular blocking control coupled to the location-based tracking system, which receives location data from the location-based tracking system. The cellular blocking control determines the speed traveled by the cellular phone between two successive determined positions. A database stores control parameters for operation of the cellular phone. The cellular blocking control utilizes the data within the database to determine whether the determined speed exceeds a predetermined speed as a control parameter. The cellular blocking control disables the cell phone when the determined speed exceeds the predetermined speed preventing the use of the cell phone during unsafe conditions.

In one embodiment of the invention disabling of the phone includes shutting down the cell phone, providing a busy signal for incoming calls, or rerouting incoming communication to another number, to voicemail or to e-mail. Virtual maps may be used by the cellular blocking control in order to determine whether the movement of the phone corresponds to a street, a railroad track, or off-road situation and allows control of the cellular phone to account for the varying degree of danger associated with each of those environments.

### BRIEF DESCRIPTION OF THE DRAWINGS

FIG. 1 is a flow chart of the method for controlling a cell phone in accordance with the invention;

FIG. 2. is a flow chart of the method for controlling a cell phone in accordance with a second embodiment of the invention; and

FIG. 3. is a schematic view of a cell phone constructed in accordance with the invention.

### DETAILED DESCRIPTION OF THE INVENTION

This invention will describe unique implementations of a cellular block method and apparatus by utilizing a unique operation algorithm implemented on the user's mobile phone. The mobile phone will use the phone's internal geo positioning satellite (GPS) device in combination with a unique control algorithm and stored parameters to direct the inbound phone call, text message, or the like (collectively and individually a “communication”), to a back up system and/or re-route the incoming calls for later retrieval and preventing outgoing calls. The algorithm includes processes, including a menu to set a predetermined value for the speed, and location of the mobile device at which the algorithm will activate. This method eliminates the need for any special network feature and/or management because the unique algorithm is embedded and/or downloaded into the mobile phone itself. This unique algorithm is referred to as Vehicle Mode.

As known from the inventors' U.S. patent application Ser. No. 11/956,067, co-pending herewith and incorporated as if fully set forth herein. Profiles including parameters for operation of a target mobile communication device are stored in a database. The database in a preferred embodiment of the present invention is embedded, stored, initialized, or down loaded to the cellular phone. The database includes the parameters under which the target mobile communication device; cellular phone, is to operate when in motion. The parameters stored within the database include operation algorithms for the mobile communication device, by way of example, one of allowing certain phone calls to pass through, providing a busy signal, diverting the communication to an email, voicemail or other communications address or the like, as well as a predetermined speed at which control of the cellular phone in accordance with the parameters is triggered. This methodology works whether the communication is attempted from the target mobile communications device or whether the mobile communications device is the target communications device; i.e. inbound communications.

The algorithm for controlling the cellular phone may be embedded, initialized or downloaded to the cellular phone. It may also reside on a server in communication with the targeted cellular phone.

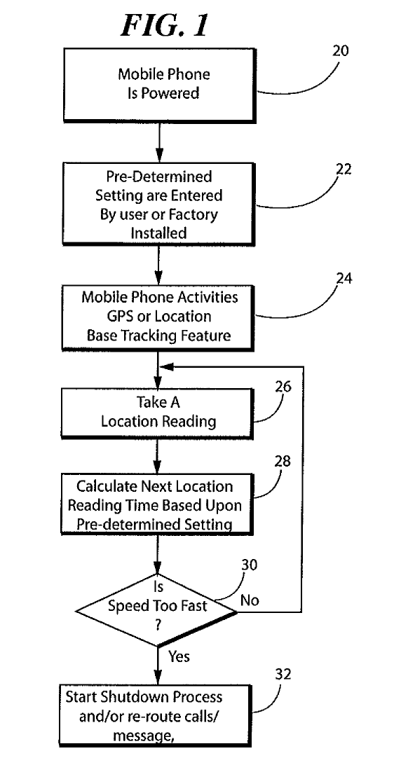

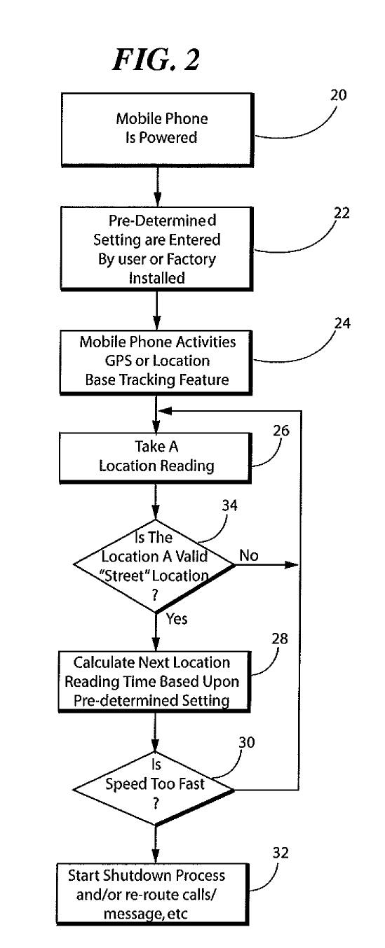

As known in the art, a cellular phone generally indicated as 10 includes an antenna 12 for communicating with a cellular communication network. Cellular phone 10 includes a position determining circuit 14 which may make use of triangulation techniques with cellular towers, geo positioning satellites (GPS) or other means as known in the art. A database 16 stores the control and operation parameters as discussed above. A cellular blocking control 18 receives input from the position determining circuit 14 and the database 16 to operate the cellular phone in accordance with the methodology shown in FIGS. 1 and 2. It is understood, that cellular phone 10 is representative of any mobile communication device and may be free standing as with a cellular phone, pager or the like, or may be embedded within a moving vehicle as known in the art with higher end vehicles, such as the BMW 700 series.

In its alternative embodiment, the parameters of database 16 may be stored remotely on a server (not shown) in communication with a mobile communications network as known in the art. The server communicating either with an automobile embedded mobile communications device or an associated mobile communications device, such as a cellular phone associated with the user registered to the vehicle, downloads the parameters for the database for operation of the algorithm.

Referring to FIG. 1, a mobile phone/device is turned on in a step 20. In one, non-limiting, embodiment, the mobile device then requests a configuration for the predetermined settings (parameters) of the Vehicle Mode feature in a step 22. This could be pre-programmed by the factory and/or provided to the user at initial configuration. Vehicle Mode Parameters, for controlling cellular communication blocking may include:
Speed or motion parameters—at which control begins
Emergency numbers—which are never blocked
Allowed in-bound/out-bound numbers—which may be blocked dependent on other party, i.e., boss, parent.
Location parameters—for changing control parameters as a function of geographical location.
ESN identifiers—control in response to certain numbers
Store and forward—incoming calls as one embodiment of disablement
Vehicle Ring Tone alerts—to indicate phone control status.

The control algorithm or parameters may also include a parental control feature which would block an under aged teenager” or any other unauthorized person from being able to re-program or alter the parameter settings. A parameter may even be a rule for allowing hands free operation while driving. In some mobile phones this algorithm can be implemented as an application for downloading such as in a “Black Berry Phone”. In other phones it would require the mobile phone manufacture to embedded the algorithm prior to the sale of the phone. It is contemplated that the mobile phone manufactures may provide this Vehicle Mode feature as a standard feature and thus embedded the application.

Once the configuration and pre-determined parameter settings are set in mobile phone 10, mobile phone 10 will use the phone's GPS or other position determining circuitry to obtain an initial location of the mobile phone in a step 24 location and take a reading in step 26. Phone 10 will then estimate the next time to take a reading as a function of the pre-determined speed parameter and/or the currently measured speed.

For example if 5 miles per hour was set as the predetermined speed at which control of cellular phone 10 shall commence, then the cellular blocking control 18 operating in accordance with an algorithm will estimate the next time cellular phone 10 would need to take a follow on location reading based upon the 5 miles per hour setting in a step 28. Cellular blocking control 18 will then compare the new location by computing time and distance traveled and determine whether the new location was reached faster then the 5-mile speed limit would allow.

The calculated speed is then compared to the predetermined speed stored in database 16 in a step 30. If the speed as determined is below the predetermined speed, the process is returned to step 26 and a follow on location reading is taken in step 26 and calculations are made regarding the current speed. Steps 26-20 are repeated until the predetermined speed is met or exceeded.

In another similar manner the predetermined speed can be validated by taking a GPS reading on a periodic basis (for example every five minutes or hour). The location distance between each successive sampling is calculated to determine whether the distance traversed required a speed greater then the predetermined value.

If it is determined that mobile phone 10 is travelling at speeds greater then the pre-determined speed in step 30 then cellular blocking control 18 will operate under algorithm control to disable phone 10 by performing at least one of shutdown or re-route all calls, text messages, and the like to the cellular systems back up storage for later retrieval in step 32. Cellular blocking control 18 may also cause a busy signal to be generated to an incoming caller. If the Vehicle Mode is activated at phone 10, cellular blocking control 18 can alert the user of the change in operation by generating a unique Vehicle Mode ring tone or other typical alert methods at cell phone 10.

Once the mobile phone is disabled, cellular blocking control 18 continues to monitor the speed of cellular phone 10, in order to re-establish normal operation once the speed is reduced below the predetermined speed.

The Vehicle Mode may include parameters or algorithm logic which causes cellular blocking control 18 to allow for normal 911 emergency calls and other emergency level features to be maintained. The Vehicle Mode may also allow for special phone numbers to be received regardless of the speed. For example home phone numbers, office numbers or the like.

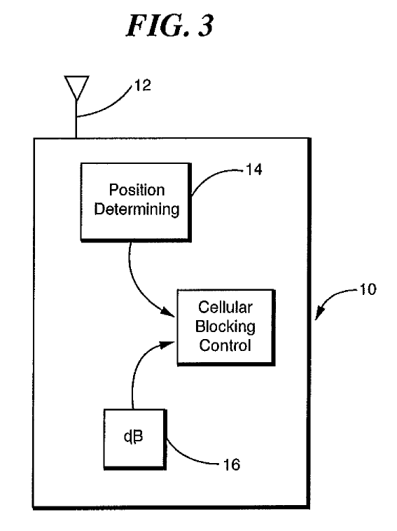

In a preferred embodiment, the mobile device/cellular phone 10 can differentiate between travel in a car, boat or other self directed vehicle which is dangerous while using a cellular phone, and movement when on a train which should allow for use of the cellular phone as it is not a dangerous activity. Therefore, in this embodiment, as shown in FIG. 3, prior to making any final control decision, cellular blocking control 18 determines whether or not the mobile phone is located on a street, rather than a train track or other non-street location. Like steps are indicated with like numerals to facilitate description of the invention.

It is know in the art to provide street maps for utilization in location-based applications, even for cellular phone 10. Such maps are readily available from MAPQUEST, GOOGLE and the like. Utilizing these maps, one can “fence” railroad tracks and compare the geographic location (physical location relative to a map) of the cellular phone in transit to the geographic location of the railroad track within the virtual location-based application map. The cellular phone itself may be able to make this determination, or a server communicating with a cellular phone communication network may be utilized.

Therefore, as shown in FIG. 3, operation by the cellular phone is as shown in FIG. 1. However, after taking a location position reading in step 26, in this embodiment of the invention cellular blocking control 18 utilized the map, either as stored in database 16 or received through antenna 12 from a third party source, to determine whether the location is a valid street location in step 34. This is done by comparing the geographic location of phone 10 either to a known street geographical location on the map and/or the fenced in railroad track geographical location. If the location of the moving mobile device does not correspond to a street or corresponds to a railroad track, as determined in step 36 no control is performed and the process is repeated at step 26. However, if location of traveling cellular phone 10 corresponds to a street position then processing continues as discussed above at step 28 and a speed is calculated and cellular phone 10 is controlled as discussed above.

It should be noted, that movement which occurs in a geographical location that does not correspond to either a street or railroad track may also require controlled use of cell phone 10. It may correspond to an off road vehicle, such as a car, truck, motorcycle or all terrain vehicle; a horse, or even a water based vehicle. Therefore, by eliminating both a street location and a railroad track location, disabling control may be conducted as well by cellular blocking control 18.

What is claimed as new and desired to be protected by Letters Patent of the United States is:

1. A cellular phone comprising:
a location based tracking system;
a cellular blocking control operatively coupled to the location-based tracking system and receiving location data from said location based tracking system, and determining a speed traveled by the cellular phone between two successive determined positions; and
a database being configured to store control parameters for operation of the cellular phone; the cellular blocking control determining whether the determined speed exceeds a predetermined speed stored in the database as a control parameter, and disabling the cellular phone when the determined speed exceeds the predetermined speed.

2. The cellular phone of claim 1, wherein said the location-based tracking system utilizes GPS.

3. The cellular phone of claim 1, wherein the location based tracking system utilizes cellular towers making up part of a cellular communications network.

4. The cellular phone of claim 1, wherein disabling is one of generating a busy signal in response to an incoming communication, shutting down the cellular phone and rerouting the incoming communication to a voicemail or email repository.

5. The cellular phone of claim 1, wherein said control parameter includes a phone number corresponding to a number for which the cellular phone is not disabled.

6. The cellular phone of claim 1, wherein said parameters are stored in said database at the time of manufacture of the cellular phone.

7. The cellular phone of claim 1, wherein at least one of said control parameters includes a parameter for preventing a user from changing the control parameters.

8. The cellular phone of claim 1, wherein the database is configured to store a location based map for determining the geographical location of at least one of a street and a railroad track.

9. A method for blocking communication with a cellular phone comprising the steps of: storing cellular phone control parameters on the cellular phone, at least one of the parameters including a predetermined speed for the cellular phone;
determining the speed of the cellular phone;
comparing the determined speed of the cellular phone to the predetermined speed; and
disabling the cellular phone if the determined speed is greater than the predetermined speed.

10. The method of claim 9, wherein, disabling is one of generating a busy signal, shutting down the cellular phone and rerouting incoming communications.

11. The method of claim 9, further providing a ring tone alert to indicate the status of the cellular phone.

12. The method of claim 9, wherein disabling includes allowing emergency phone calls to be processed.

13. The method of claim 9 further comprising the steps of: determining the geographic location of a street;
determining the geographic location of the cellular phone;
comparing the geographic location of the street to the geographic location of the cellular phone; and
preventing disabling of the cellular phone if the geographic location of the cellular phone does not correspond to the geographic location of the street.

14. The method of claim 9, further comprising the steps of:
determining the geographic location of a railroad track;
determining the geographic location of the cellular phone;
comparing the geographic location of the cellular phone and the geographic location of the railroad track; and
preventing disabling of the cellular phone when the geographic location of the railroad track corresponds to the geographic location of the cellular phone.

15. The method of claim 9, comprising the steps of:
determining the geographic location of a street;
determining the geographic location of a railroad track;
determining the geographic location of the cellular phone; and
disabling the cellular phone if the measured speed is greater than the predetermined speed and the geographic location of the cellular phone does not correspond to the geographic location of the railroad track and the geographic location of the street.

16. The method of claim 9, further comprising the step of storing the control parameters in the database at the time of manufacture.

17. The method of claim 9, further comprising the step of storing the control parameters by downloading the control parameters to the cellular phone.

18. The method claim 9, wherein said control parameters include parameters for allowing change of the control parameters only by predetermined persons.
